(19) United States
(12) Patent Application Publication
(10) Pub. No.: US 2017/0026578 A1
(43) Pub. Date: Jan. 26, 2017

(54) NETWORK CAMERA SYSTEM AND NETWORK CAMERA THEREOF

(71) Applicant: VIVOTEK INC., New Taipei City (TW)

(72) Inventor: Ming-Tsung Chen, New Taipei City (TW)

(21) Appl. No.: 15/199,967

(22) Filed: Jun. 30, 2016

(30) Foreign Application Priority Data
Jul. 24, 2015 (TW) 104124003

(51) Int. Cl. H04N 5/232; H04N 5/225; H04N 5/247; H04L 12/10; H04M 3/00

(52) U.S. Cl. CPC H04N 5/23241; H04L 12/10; H04M 3/007; H04N 5/247; H04N 5/2252

(57) ABSTRACT

A network camera system includes a transmitting device, a network camera, and a shunt device. The transmitting device provides a network power, receives an Ethernet signal and includes a power transforming unit for transforming an external power into the network power and a signal transforming unit for transforming the Ethernet signal into an xDSL signal. The network camera includes a casing and a main board disposed in the casing. The shunt device is connected to the main board and the transmitting device and includes a signal transceiving unit and a power transceiving unit. The signal transceiving unit transforms the xDSL signal back into the Ethernet signal for performing Ethernet signal transmission between the shunt device and the main board. The power transceiving unit is used for selectively transmitting the network power to the main board as an operating power of the network camera.

### BACKGROUND OF THE INVENTION

1. Field of the Invention

The present invention relates to a network camera system and a network camera thereof, and more specifically, to a network camera system for transforming an Ethernet signal into an xDSL (x Digital Subscriber Line) signal to perform network signal transmission between a network camera and a transmitting device and a network camera thereof.

2. Description of the Prior Art

In general, a network camera utilizes a power cable to connect to an external power source for obtaining an external power, and utilizes a network cable to connect to a control terminal (e.g. a video surveillance host) for establishing network signal transmission between the control terminal and the network camera. However, when there are numerous network cameras needed to be set up, each network camera must be connected to the external power source and the control terminal respectively, so as to cause a complicated wiring process.

Via a PoE (Power over Ethernet) switch coupled to the external power source, the network camera could only utilize a network cable to obtain electrical power and establish network signal transmission between the control terminal and the network camera simultaneously. However, due to limitation of Ethernet network transmission, a wiring distance between the PoE switch and the network camera needs to be less than 100 m, or signal attenuation may occur to cause incorrect signal transmission if the wiring distance is larger than 100 m. Accordingly, convenience and flexibility for setting up the network camera could be greatly influenced.

### SUMMARY OF THE INVENTION

The present invention provides a network camera system. The network camera system includes a transmitting device, a first network camera and a first shunt device. The transmitting device is used for providing a network power and receiving an Ethernet signal. The transmitting device includes a power transforming unit and a signal transforming unit. The power transforming unit is used for transforming an external power transmitted from an external power source into the network power. The signal transforming unit is used for transforming the Ethernet signal into an xDSL signal. The first network camera includes a first casing and a first main board. The first main board is disposed in the first casing for operating the first network camera. The first shunt device is connected to the first main board and connected to the transmitting device in a network cable connection manner. The first shunt device includes a first signal transceiving unit and a first power transceiving unit. The first signal transceiving unit is used for transforming the xDSL signal back into the Ethernet signal so as to perform Ethernet signal transmission between the first shunt device and the first main board. The first power transceiving unit is used for selectively transmitting the network power to the first main board as an operating power of the first network camera.

The present invention further provides a network camera for performing Ethernet signal transmission and network power transmission with a transmitting device. The transmitting device is used for transforming an external power transmitted from an external power source into a network power and transforming an Ethernet signal into an xDSL signal. The transmitting device is connected to the network camera via a network cable and transmits the network power and the xDSL signal via the network cable. The network camera includes a casing, a main board, and a shunt device. The main board is disposed in the casing for operating the network camera. The shunt device is connected to the main board and connected to the transmitting device in a network cable connection manner. The shunt device includes a signal transceiving unit and a power transceiving unit. The signal transceiving unit is used for transforming the xDSL signal back into the Ethernet signal so as to perform Ethernet signal transmission between the shunt device and the main board. The power transceiving unit is used for selectively transmitting the network power to the main board as an operating power of the network camera.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a network camera system according to an embodiment of the present invention.

FIG. 2 is a functional block diagram of the network camera system in FIG. 1.

### DETAILED DESCRIPTION

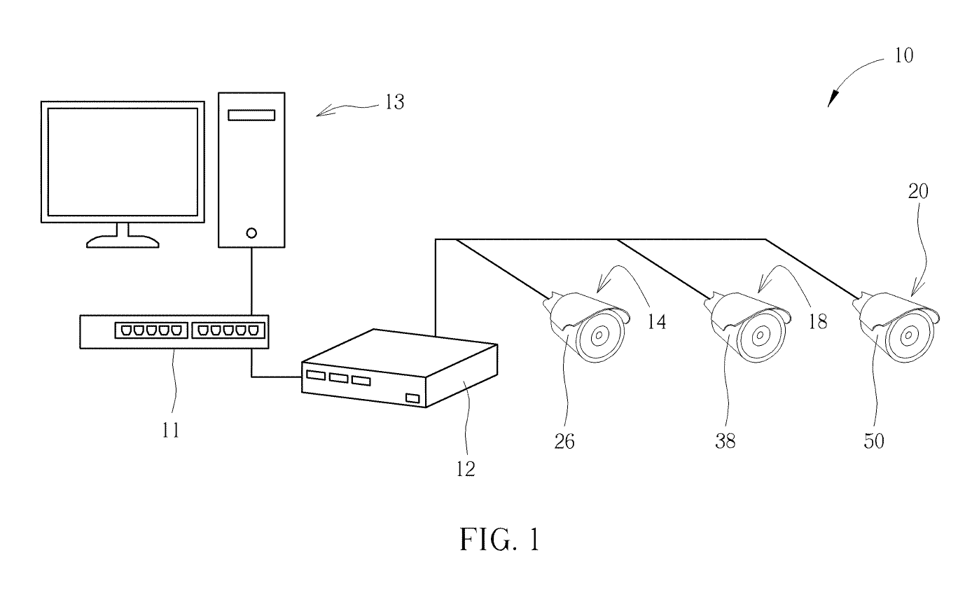

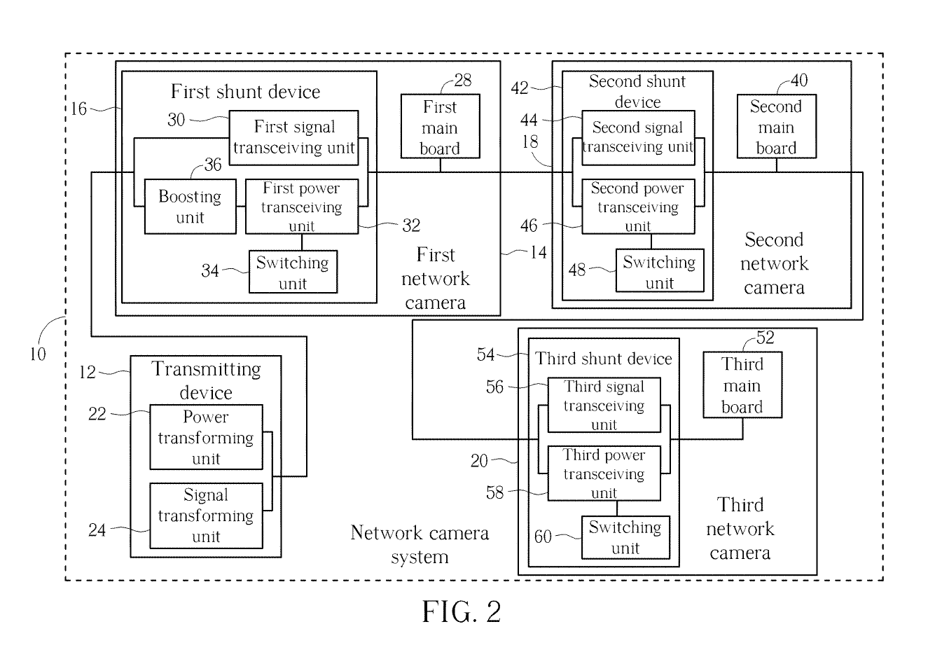

Please refer to FIG. 1 and FIG. 2. FIG. 1 is a diagram of a network camera system 10 according to an embodiment of the present invention. FIG. 2 is a functional block diagram of the network camera system 10 in FIG. 1. As shown in FIG. 1 and FIG. 2, the network camera system 10 includes a transmitting device 12, a first network camera 14, a first shunt device 16, a second network camera 18, and a third network camera 20. Amount of the first network camera 14, the second network camera 18 and the third network camera 20 is not limited to one as shown in FIG. 1, but could vary with the practical application of the network camera system 10. The transmitting device 12 is connected to the first network camera 14 and a control terminal (e.g. a video surveillance host) and includes a power transforming unit 22 and a signal transforming unit 24. The power transforming unit 22 is used for transforming an external power transmitted from an external power source (e.g. the mains supply) into a network power. The signal transforming unit 24 is used for transforming an Ethernet signal into an xDSL (x Digital Subscriber Line) signal. The xDSL signal could be, but not limited thereto, an ADSL (Asymmetric DSL) signal, an SDSL (Symmetrical DSL) signal, an HDSL (High Data Rate DSL) signal, a VDSL (Very High Data Rate DSL) signal, or a VoDSL (Voice over DSL) signal. To be more specific, if the transmitting device 12 is connected to a control terminal 13 via a non-PoE switch 11 (as shown in FIG. 1), the signal transmitting unit 24 could be used for transforming the Ethernet signal transmitted from the control terminal 13 via the non-PoE switch 11 into the xDSL signal, and the power transforming unit 22 could be used for transforming an external power in an alternating current mode transmitted from the external power source connected to the transmitting device 12 into the network power in a direct current mode, so as to provide the network power to the first network camera 14 and establish network signal transmission between the first network camera 14 and the control terminal 13 for image surveillance. On the other hand, if the transmitting device 12 is connected to a control terminal via a PoE switch, the power transforming unit 22 could directly transmit the network power received from the PoE switch to the first network camera 14 without performing power transformation since the PoE switch has already transformed the external power in the alternating current mode transmitted from the external power source connected to the transmitting device 12 into the network power in the direct current mode. Accordingly, the transmitting device 12 just needs to utilize the signal transforming unit 24 to transform the Ethernet signal transmitted from the control terminal via the PoE switch into the xDSL signal. As for related description for the Ethernet network power supply principle and network signal transformation principle of the transmitting device 12, it is commonly seen in the prior art and omitted herein.

As shown in FIG. 1 and FIG. 2, the first network camera 14 includes a first casing 26 and a first main board 28. The first main board 28 is disposed in the first casing 26 for performing operations of the first network camera 14, such as image capturing. In this embodiment, the first shunt device 16 is disposed in the first casing 26, but not limited thereto, meaning that the network camera system 10 could adopt the design that the first shunt device 16 is an independent apparatus to be connected to the first network camera 14. The first shunt device 16 is connected to the first main board 28 and is connected to the transmitting device 12 via a network cable for power shunting and network signal transmission. To be more specific, the first shunt device 16 includes a first signal transceiving unit 30 and a first power transceiving unit 32. The first signal transceiving unit 30 could be used for transforming the xDSL signal transmitted from the transmitting device 12 back into the Ethernet signal, so as to perform Ethernet signal transmission between the first shunt device 16 and the first main board 28. In such a manner, the network camera system 10 could perform related image processing operations of the first network camera 14 (e.g. image transmission, image capturing, or capturing angle adjustment).

For improving power selection flexibility of the first network camera 14, the first power transceiving unit 32 could be used for selectively performing the power shunting operation on the network power transmitted from the transmitting device 12 according to the practical power selection of the first network camera 14. To be more specific, as shown in FIG. 2, in this embodiment, the first shunt device 16 could further include a switching unit 34. The switching unit 34 is connected to the first power transceiving unit 32 for controlling the first power transceiving unit 32 to transmit a first shunt power or the external power in the alternating current mode, which is transmitted from the external power source connected to the first network camera 14, to the first main board 28 as an operating power of the first network camera 14.

In such a manner, if the network power transmitted from the transmitting device 12 is used as the operating power of the first network camera 14, the switching unit 34 could control the first power transceiving unit 32 to shunt the first shunt power from the network power to the first main board 28, so that the first main board 28 could utilize the first shunt power to operate the first network camera 14. On the other hand, if the external power in the alternating current mode transmitted from the external power source is used as the operating power of the first network camera 14, the switching unit 34 could control the first power transceiving unit 32 to transmit the external power in the alternating current mode to the first main board 28 as the operating power of the first network camera 14. To be noted, the external power transmitted from the external power source needs to be transformed in advance into the external power suitable for the first network camera 14, the first power transceiving unit 32 or the first main board 28, and then is transmitted to the first main board 28 via the first power transceiving unit 32 as the operating power of the first network camera 14. The aforesaid power transformation process is known to one skilled in the prior art, and the related description is omitted herein.

Via the aforesaid design, due to the long distance transmission capability of the xDSL signal, the network camera system 10 could utilize a network cable (e.g. Cat.5 cable) suitable for xDSL signal transmission to insert into a corresponding connection port (e.g. RJ45 port) for establishing long distance transmission between the transmitting device 12 and the first network camera 14. Accordingly, the present invention could efficiently solve the prior art problem that the wiring distance of Ethernet signal transmission between the PoE switch and the network camera is too short (less than 100 m), so as to greatly improve convenience and flexibility for setting up the network camera. For example, in the embodiment that the transmitting device 12 could provide a 65W network power and the first network camera 14 is a 10W bullet IP camera, the network camera system 10 could utilize a 900 m Cat.5 cable or a 1000 m Cat.6 cable to establish electrical connection and network signal transmission between the transmitting device 12 and the first network camera 14. In the embodiment that the transmitting device 12 could provide a 120W network power and the first network camera 14 is a 48W speed dome IP camera, the network camera system 10 could utilize a 400 m Cat.6 cable to establish electrical connection and network signal transmission between the transmitting device 12 and the first network camera 14. As for related description for other derived embodiments, it could be reasoned by analogy according to the aforesaid embodiment. In other words, all designs that the transmitting device is used for transforming the Ethernet signal into the xDSL signal for increasing the wiring distance between the transmitting device and the network camera may fall within the scope of the present invention.

In practical application, as shown in FIG. 2, the first shunt device 16 could further include a boosting unit 36. The boosting unit 36 is coupled to the transmitting device 12 and the first power transceiving unit 32 for boosting the network power transmitted from the transmitting device 12 and then transmitting the network power to the first power transceiving unit 32, so as to solve the voltage drop problem caused by long distance transmission of the network power. Accordingly, the network power received by the first power transceiving unit 32 could have a sufficient voltage and could be shunted to the first network camera 14.

The second network camera 18 could have the same design with the first network camera 14 and the related description could be reasoned by analogy according to the aforesaid embodiment. That is, as shown in FIG. 1 and FIG. 2, the second network camera 18 is connected to the first network camera 14 via a network cable and includes a second casing 38, a second main board 40, and a second shunt device 42. The second main board 40 is disposed in the second casing 38 for performing operations of the second network camera 18, such as image capturing. The second shunt device 42 is disposed in the second casing 38 and is connected to the second main board 40 and connected to the first network camera 14 for power shunting and network signal transmission. To be more specific, the second shunt device 42 includes a second signal transceiving unit 44 and a second power transceiving unit 46. The second signal transceiving unit 44 could be used for performing network signal transmission between the transmitting device 12 and the second main board 40. In such a manner, the network camera system 10 could perform related image processing operations of the second network camera 18 (e.g. image transmission, image capturing, or capturing angle adjustment) in a signal transmission manner.

For improving power selection flexibility of the second network camera 18, the second power transceiving unit 46 could be used for selectively performing the power shunting operation on the network power transmitted from the transmitting device 12 according to the practical power selection of the second network camera 18. To be more specific, as shown in FIG. 2, in this embodiment, the second shunt device 42 could further include a switching unit 48. The switching unit 48 is connected to the second power transceiving unit 46 for controlling the second power transceiving unit 46 to transmit a second shunt power or the external power in the alternating current mode, which is transmitted from the external power source connected to the second network camera 18, to the second main board 40 as an operating power of the second network camera 18.

In such a manner, if the network power transmitted from the transmitting device 12 is used as the operating power of the first network camera 14 and the operating power of the second network camera 18, the switching unit 34 could control the first power transceiving unit 32 to shunt the first shunt power from the network power to the first main board 28, and the switching unit 48 could control the second power transceiving unit 46 to shunt the second shunt power from a remaining power after the network power passes through the first network camera 14 to the second main board 40. Accordingly, the second main board 40 could utilize the second shunt power to operate the second network camera 18. On the other hand, if the external power in the alternating current mode transmitted from the external power source is used as the operating power of the second network camera 18, the switching unit 48 could control the second power transceiving unit 46 to transmit the external power in the alternating current mode to the second main board 40 as the operating power of the second network camera 18. As for other derived embodiments for power selection (e.g. the first network camera 14 utilizes the external power in the alternating current mode transmitted from the external power source and the second network camera 18 utilizes the network power transmitted from the transmitting device 12), the related description could be reasoned by analogy according to the aforesaid embodiments and omitted herein.

The third network camera 20 could have the same design with the first network camera 14 and the second network camera 18 and the related description could be reasoned by analogy according to the aforesaid embodiments. That is, as shown in FIG. 1 and FIG. 2, the third network camera 20 is connected to the second network camera 18 via a network cable and includes a third casing 50, a third main board 52, and a third shunt device 54. The third main board 52 is disposed in the third casing 50 for performing operations of the third network camera 20, such as image capturing. The third shunt device 54 is disposed in the third casing 50 and is connected to the third main board 52 and connected to the second network camera 18 for power shunting and network signal transmission. To be more specific, the third shunt device 54 includes a third signal transceiving unit 56 and a third power transceiving unit 58. The third signal transceiving unit 56 could be used for performing network signal transmission between the transmitting device 12 and the third main board 52. In such a manner, the network camera system 10 could perform related image processing operations of the third network camera 20 (e.g. image transmission, image capturing, or capturing angle adjustment) in a signal transmission manner.

For improving power selection flexibility of the third network camera 20, the third power transceiving unit 58 could be used for selectively performing the power shunting operation on the network power transmitted from the transmitting device 12 according to the practical power selection of the third network camera 20. To be more specific, as shown in FIG. 2, in this embodiment, the third shunt device 54 could further include a switching unit 60. The switching unit 60 is connected to the third power transceiving unit 58 for controlling the third power transceiving unit 58 to transmit a third shunt power or the external power in the alternating current mode, which is transmitted from the external power source connected to the third network camera 20, to the third main board 52 as an operating power of the third network camera 20.

In such a manner, if the network power transmitted from the transmitting device 12 is used as the operating power of the first network camera 14, the operating power of the second network camera 18 and the operating power of the third network camera 20, the switching unit 60 could control the third power transceiving unit 58 to shunt the third shunt power from a remaining power after the network power passes through the first network camera 14 and the second network camera 18 to the third main board 52, Accordingly, the third main board 52 could utilize the third shunt power to operate the third network camera 20. To be noted, as shown in FIG. 1, since the third network camera 20 could be regarded as a terminal network camera in this embodiment, the third network camera 20 could directly transmit the aforesaid remaining power to the third main board 52 without performing the power shunting operation, and could perform Ethernet signal transmission between first shunt device 16 and the third main board 52 via the third signal transceiving unit 56.

On the other hand, if the external power in the alternating current mode transmitted from the external power source is used as the operating power of the third network camera 20, the switching unit 60 could control the third power transceiving unit 58 to transmit the external power in the alternating current mode to the third main board 52 as the operating power of the third network camera 20. As for other derived embodiments for power selection (e.g. the second network camera 18 utilizes the external power in the alternating current mode transmitted from the external power source and the first network camera 14 and the third network camera 20 utilize the network power transmitted from the transmitting device 12), the related description could be reasoned by analogy according to the aforesaid embodiments and omitted herein.

It should be mentioned that amount of network camera in serial connection is not limited to three as mentioned in the aforesaid embodiments. In other words, in the condition that the connection length of the network cable does not exceed the allowable network signal transmission distance and power needed for operations of the network camera could be obtained from the aforesaid power shunting method or the external power source, the amount of network camera in serial connection could vary with the practical application of the network camera system 10. Furthermore, the aforesaid switching unit could be an omissible component for simplifying the design of the network camera. For example, in the embodiment that the switching unit is omitted, the power transceiving unit could be used for transmitting the external power in the alternating current mode to the main board as the operating power of the network camera when determining that the network camera is connected to the external power source. Moreover, in another embodiment, if the first network camera 14 is the only one network camera in the network camera system 10, the first network camera 14 could directly transmit the network power to the first main board 28 as the operating power of the first network camera 14 without performing the aforesaid power shunting operation, and could perform Ethernet signal transmission between the first shunt device 16 and the first main board 28 via the first signal transceiving unit 30.

In summary, the present invention utilizes the transmitting device to transform the Ethernet signal into the xDSL signal for increasing the allowable wiring distance between the transmitting device and the network camera. In such a manner, the network camera system provided by the present invention could utilize the network cable suitable for xDSL network transmission to perform the long distance transmission between the transmitting device and the network camera, so as to efficiently solve the prior art problem that the wiring distance between the PoE switch and the network camera needs to be less than 100 m due to limitation of Ethernet network transmission. Accordingly, convenience and flexibility for setting up the network camera could be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network camera system comprising:
a transmitting device for providing a network power and receiving
an Ethernet signal, the transmitting device comprising:
a power transforming unit for transforming an external power transmitted from an external power source into the network power; and
a signal transforming unit for transforming the Ethernet signal into an xDSL (x Digital Subscriber Line) signal;
a first network camera comprising:
a first casing; and
a first main board disposed in the first casing for operating the first network camera; and
a first shunt device connected to the first main board and connected to the transmitting device in a network cable connection manner, the first shunt device comprising:
a first signal transceiving unit for transforming the xDSL signal back into the Ethernet signal so as to perform Ethernet signal transmission between the first shunt device and the first main board; and
a first power transceiving unit for selectively transmitting the network power to the first main board as an operating power of the first network camera.

2. The network camera system of claim 1, wherein the first shunt device is disposed in the first casing.

3. The network camera system of claim 1, wherein the power transceiving unit shunts a first shunt power from the network power transmitted by the transmitting device to the first main board as the operating power of the first network camera.

4. The network camera system of claim 3, wherein when the first power transceiving unit determines that the first network camera is coupled to the external power source, the first power transceiving unit is further used for transmitting the external power in an alternating current mode to the first main board as the operating power of the first network camera.

5. The network camera system of claim 4, wherein the first shunt device further comprises:
a first switching unit connected to the first power transceiving unit for controlling the first power transceiving unit to transmit the first shunt power or the external power in the alternating current mode to the first main board as the operating power of the first network camera.

6. The network camera system of claim 1, wherein the first shunt device further comprises a boosting unit coupled to the transmitting device and the first power transceiving unit for boosting the network power and then transmitting the network power to the first power transceiving unit as the operating power of the first network camera.

7. The network camera system of claim 3 further comprising:
at least one second network camera connected to the first network camera in a network cable connection manner, the at least one second network camera comprising:
a second casing;
a second main board disposed in the second casing for operating the at least one second network camera; and
a second shunt device disposed in the second casing and connected to the second main board and the first shunt device, the second shunt device comprising:
a second signal transceiving unit for performing Ethernet signal transmission between the first shunt device and the second main board; and
a second power transceiving unit for selectively shunting a second shunt power from a first remaining power after the network power passes through the first network camera to the second main board as an operating power of the at least one second network camera.

8. The network camera system of claim 7 further comprising:
at least one third network camera connected to the at least one second network camera in a network cable connection manner, the at least one third network camera comprising:
a third casing;
a third main board disposed in the third casing for operating the at least one third network camera; and
a third shunt device disposed in the third casing and connected to the third main board and the second shunt device, the third shunt device comprising:
a third signal transceiving unit for performing Ethernet signal transmission between the first shunt device and the third main board; and
a third power transceiving unit for selectively providing a second remaining power after the network power passes through the first network camera and the at least one second network camera to the third main board as an operating power of the at least one third network camera.

9. The network camera system of claim 7 further comprising:
a third network camera connected to the at least one second network camera in a network cable connection manner, the at least one third network camera comprising:
a third casing; and
a third main board disposed in the third casing for operating the third network camera, the second power transceiving unit being used for selectively transmitting a second remaining power after the network power passes through the first network camera and the at least one second network camera to the third main board as an operating power of the at least one third network camera, the second signal transceiving unit being used for performing Ethernet signal transmission between the first shunt device and the third main board.

10. The network camera system of claim 1, wherein the xDSL signal is an ADSL (Asymmetric DSL) signal, an SDSL (Symmetrical DSL) signal, an HDSL (High Data Rate DSL) signal, a VDSL (Very High Data Rate DSL) signal, or a VoDSL (Voice over DSL) signal.

11. A network camera for performing Ethernet signal transmission and network power transmission with a transmitting device, the transmitting device being used for transforming an external power transmitted from an external power source into a network power and transforming an Ethernet signal into an xDSL signal, the transmitting device being connected to the network camera via a network cable and transmitting the network power and the xDSL signal via the network cable, the network camera comprising:
a casing;
a main board disposed in the casing for operating the network camera; and
a shunt device connected to the main board and connected to the transmitting device in a network cable connection manner, the shunt device comprising:
a signal transceiving unit for transforming the xDSL signal back into the Ethernet signal so as to perform Ethernet signal transmission between the shunt device and the main board; and
a power transceiving unit for selectively transmitting the network power to the main board as an operating power of the network camera.

12. The network camera of claim 11, wherein the power transceiving unit shunts a shunt power from the network power transmitted by the transmitting device to the main board as the operating power of the network camera.

13. The network camera of claim 12, wherein when the power transceiving unit determines that the network camera is coupled to the external power source, the power transceiving unit is further used for transmitting the external power in an alternating current mode to the main board as the operating power of the network camera.

14. The network camera of claim 13, wherein the shunt device further comprises:
a switching unit connected to the power transceiving unit for controlling the power transceiving unit to transmit the shunt power or the external power in the alternating current mode to the main board as the operating power of the network camera.

15. The network camera of claim 11, wherein the shunt device further comprises a boosting unit coupled to the transmitting device and the power transceiving unit for boosting the network power and then transmitting the network power to the power transceiving unit as the operating power of the network camera.

16. The network camera of claim 12, wherein the shunt device is connected to another network camera in a network cable connection manner, the power transceiving unit is used for transmitting a remaining power after the network power passes through the network camera to the another network camera, and the signal transceiving unit is used for performing Ethernet signal transmission between the transmitting device and the another network camera.

17. The network camera of claim 11, wherein the xDSL signal is an ADSL signal, an SDSL signal, an HDSL signal, a VDSL signal, or a VoDSL signal.
